(19) United States
(12) Patent Application Publication
(10) Pub. No.: US 2018/0347232 A1
(43) Pub. Date: Dec. 6, 2018

(54) A LOCK MONITORING DEVICE AND A LOCK MONITORING SYSTEM

(71) Applicant: Peter Alexander Cordiner, Cape Town (ZA)

(72) Inventor: Peter Alexander Cordiner, Cape Town (ZA)

(21) Appl. No.: 15/562,320

(22) PCT Filed: Mar. 23, 2016
(86) PCT No.: PCT/IB2016/051637

§ 371 Date: Sep. 27, 2017

(30) Foreign Application Priority Data
Mar. 27, 2015 (ZA) 2015/02115

(51) Int. Cl. E05B 45/06; G08B 13/06; E05B 65/00; E05G 1/10

(52) U.S. Cl. CPC E05B 45/06; E05G 1/10; E05B 65/0075; G08B 13/06

(57) ABSTRACT

A lock monitoring device (10) for monitoring sensors associated with one or more locks and reporting any changes thereto is provided. The device (10) includes a housing (12) that is securable to or adjacent a lock. The housing (12) includes a plurality of ports (14) for a wired connection between the device (10) and the sensors. Each port (14) is connected to a dock (16) in which is received a monitoring module (22). The monitoring module (22) includes a processing module (28) configured to encode a monitor signal received from one or more of the sensors and a communications module (24) capable of communicating with a remote location (26) to send the monitor signal thereto. In an embodiment communication between the communications module (24) and the remote location (26) is encrypted. In an embodiment the monitoring module (22) is configured to push information to the remote location (26).

### CROSS-REFERENCE(S) TO RELATED APPLICATIONS

This application claims priority from South African provisional patent application number 2015/02115 filed on 27 Mar. 2015.

### FIELD OF THE INVENTION

This invention relates to a lock monitoring device and a lock monitoring and reporting method and system.

### BACKGROUND TO THE INVENTION

A wide variety of locking systems exist. Many systems rely on electronic locks, which themselves operate in different manners. The mechanisms of the electronic locks may, for instance, incorporate motorised dead bolts, swing bolts, magnetic fields, pins, solenoids, electric latch, worm gear drives which may be single or redundant with two motors and the like.

At present, electronic locks which offer some degree of security require a coded signal to operate. The coded signal is typically sent from an encrypted keypad, a card, disc, application specific integrated circuit (ASIC), a keypad sending approximately 12 different voltages based on 12 different resistor values triggered by each key press, from a computer or the like using secure software. On receipt of the coded signal, a processor in the lock decodes the signal and operates the lock in consequence thereof.

Although current electronic locks typically offer features which enable them to be remotely monitored, these features are often difficult to use as they rely on proprietary software and systems which are not easily integrated into third party systems. The problem is exacerbated where locks from different manufacturers are used, each relying on different software and protocols to monitor. Also, it is generally required to provide an external source of power to the lock to enable such monitoring to take place. In many instances this can be problematical due to the location of the lock.

Systems which monitor locks can provide real time information but this is often of little value where a large number of locks is being monitored as an operator can find it difficult to distinguish between authorised and unauthorised use of a lock simply by looking at the information presented. For example, if twenty five thousand ATM locks are being monitored, there may be a few dozen or hundred locks being operated at any one time. An operator in a control room will be presented with information showing operation of the numerous locks but will find it extremely difficult to distinguish authorised operation of a lock from unauthorised operation in such circumstances. The systems are thus generally used for audit purposes of unauthorised operation of a lock and not for pro-active monitoring thereof.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with this invention there is provided a lock monitoring device which includes a housing securable to or adjacent a lock with a plurality of ports provided on the housing for wired connection to sensors on one or more locks, each port connected to a dock in which is received a monitoring module, and wherein the monitoring module includes a communications module capable of communicating with a remote location to send a monitor signal thereto and a processing module configured to encode the monitor signal.

Further features of the invention provide for the dock to be accessible externally of the housing, preferably for the dock to include a socket in the housing; for sensors from a plurality of locks to be connectable to the monitoring device; for plug-type connectors to be provided for connecting the sensors to the monitoring device; and for the housing to have a standard safe lock footprint, such as a three or four wheel mechanical combination lock footprint.

Yet further features of the invention provide for the processor module to include at least one unique identifier; for the at least one unique identifier to include the geographical coordinates and altitude of the monitoring device, which are preferably hardcoded into the processor module; and for communication between the communication module and the remote location to be encrypted. Alternatively for the monitoring module to include a location detection system capable of determining the geographic location and altitude of the monitoring module; and for the location detection system to include one or more of a Global Positioning System (GPS), a Local Positioning System (LPS), a Wireless Positioning System (WPS), a barometric altimeter, an aneroid altimeter, a sensitive altimeter, a phase radio-altimeter, a sonic altimeter, a radar altimeter and the like.

Still further features of the invention provide for the remote location to include a computing device; for the computing device to be any one of an application server, personal computer, laptop computer, tablet computer, a personal digital assistant, a mobile phone running on or capable of communicating over a network and the like; and for the monitoring module to be configured to push information to the remote location.

Further features of the invention provide for the communications module to communicate over a wired or wireless communications channel with the remote location and for such communication to be encrypted; in the case of a wireless communications channel, for the channel to include any one of a local wireless network (WiFi), third generation (3G), fourth generation (4G), high-speed downlink packet access (HSDPA), general packet radio service (GPRS), short message service (SMS), unstructured supplementary service data (USSR), near-field communication (NFC), Bluetooth, infrared, or GSM protocols and the like; and in the case of wired communications channel, for the monitoring device to preferably be powered through the wired communications cable utilizing I2C protocols or the like.

Further features of the invention provide for the monitoring module to be configured to push information to the remote location.

Yet further features of the invention provide for the monitoring device to be capable of receiving a hardware key or a high security dongle; and for the monitoring device to be capable of sounding an alarm or siren in response to changes detected by the one or more sensors.

The invention further provides a housing for a monitoring device substantially as defined above.

The invention yet further provides a monitoring module receivable in a dock of a housing and which includes a processing module configured to encode a monitor signal received from a sensor connected to the housing and a communications module capable of communicating with a remote location to send the encoded monitor signal to the remote location.

The invention still further provides for a lock monitoring and reporting method, the method including the steps of, at a remotely accessible server:
receiving a monitor signal from a lock monitoring device, the monitor signal including a unique identifier of a lock and information of a condition change detected by a sensor associated with the lock;
comparing the received unique identifier with a list of identifiers stored on a system database and retrieving expected sensor condition information associated with the unique identifier of the lock;
comparing the condition change information with the retrieved expected sensor condition information; and
if the condition change information does not match the expected sensor condition information transmitting a condition change alert to a display device.

Further features of the invention provide for the monitor signal to be encrypted; for the method to include the further step of decrypting the received monitor signal; and for the expected sensor condition information to include a logical sensor condition.

Further features of the invention provide for the remotely accessible server to be in communication with the lock and configured to initiate a locking procedure of the lock in the event that the condition change information does not match the expected sensor condition information; and for the remotely accessible server to be configured to sound an alarm or siren, or activate cameras located in close proximity to the lock monitoring device in the event that the condition change information does not match the expected sensor condition information.

Yet further features of the invention provide for the display device to include one or more of an application server, personal computer, laptop computer, tablet computer, a personal digital assistant or any suitable mobile communications device such as a mobile phone, a smart phone, a smart watch, smart glasses, intelligent clothing or the like; for the condition change alert to be in the form a text message, an email, a phone call, a USSD notification or the like; for the condition change alert to optionally sound an alarm or siren, or activate cameras located in close proximity to the lock monitoring device; and for the remotely accessible server to be in communication with the lock, alternatively with a secondary server in communication with the lock, and to be configured to initiate a locking procedure of the lock.

Still further features of the invention provide for the remotely accessible server to be in communication with a plurality of lock monitoring devices; and for each lock monitoring device to be in communication with one or more sensors associated with one or more locks.

The invention still further provides for a lock monitoring and reporting system, the system including a remotely accessible server comprising:
a monitor signal receiving module which receives a monitor signal from a lock monitoring device, the monitor signal including a unique identifier of the lock monitoring device and information of a condition change detected by a sensor associated with a lock;
an identifier comparing module which compares the unique identifier of the lock monitoring device with a list of identifiers stored on a system database;
an expected condition information retrieving module which retrieves from the system database expected sensor condition information associated with the unique identifier of the lock monitoring device;
a condition change information comparing module which compares the information of the condition change detected by the sensor with the expected sensor condition information; and
a condition change alert module which transmits a condition change alert to one or more display devices when the information of the condition change detected by the sensor does not match the expected sensor condition information.

Further features of the invention provide for the remotely accessible server to include an expected sensor condition setting module which enables setting of expected sensor conditions and to associate them with a lock monitoring device; for the remotely accessible server to further include an authentication module which authenticates a user prior to enabling setting of expected sensor conditions; and for the expected sensor condition information to include a logical sensor condition.

Yet further features of the invention provide for the monitor signal to be encrypted; and for the remotely accessible server to include a monitor signal decryption module which decrypts the received monitor signal.

Still further features of the invention provide for the display device to include one or more of an application server, personal computer, laptop computer, tablet computer, a personal digital assistant or any suitable mobile communications device such as a mobile phone, a smart phone, a smart watch, smart glasses, intelligent clothing or the like; for the condition change alert to be in the form of a text message, an email, a phone call, a USSD message or the like; for the condition change alert to optionally sound an alarm or siren, or activate cameras located in close proximity to the lock monitoring device; and for the remotely accessible server to further include lock activation transmitting module for transmitting lock activation notification to the lock, alternatively with to a secondary server in communication with the lock, so as to initiate a locking procedure of the lock.

Further features of the invention provide for the remotely accessible server to be in communication with a plurality of lock monitoring devices; and for each lock monitoring device to be in communication with one or more sensors associated with one or more locks.

The invention further provides an operating device for a lock having an internal processor and an external input means connected thereto which permits operating instructions to be provided to the internal processor, the operating device comprising an external processor module within a housing and configured to be connected to the internal processor through a processor port provided on the housing, the external processor module further configured to provide operating instructions to the internal processor in the same format as those of the external input means and being operable from a remote location through a communications module within the housing to provide such operating instructions.

Further features of the invention provide for the external processor module to be connected to the lock between the lock and the external input means; and for the external processor module to be connected such that signals from the external input means are directed through the external processor module to the internal processor.

Yet further features of the invention provide for the operating device to be provided with a plurality of sensor ports provided on the housing for wired connection to sensors on the lock to enable the external processor module to monitor such sensors.

Still further features of the invention provide for external processor module to be capable of encrypted communication with the remote location; and for the housing to further provide a connector to permit a hardware key or a high security dongle to be connected to the operating device.

The invention yet further provides a method of operating a lock having an internal processor and an external input means connected thereto which external input means permits operating instructions to be provided to the internal processor, the method including the steps of:
connecting an external processor module to the internal processor, the external processor module being operable from a remote location; and
operating the external processor module from the remote location through a secure communications channel to provide operating instructions to the internal processor in the same format as those of the external input means.

Further features of the invention provide for the external processor module to be connected to the lock between the lock and the external input means; for the external processor module to be connected such that signals from the external input means are directed through the external processor module to the internal processor; and for operation of the lock to include programming or re-programming of the lock.

Still further features of the invention provide for a secure communications channel between the remote location and the external processor module to be provided by encoding such communication.

Embodiments of the invention will now be described, by way of example only, with reference to the accompanying drawings.

### BRIEF DESCRIPTION OF THE DRAWINGS

In the drawings:

FIG. 1 is a block diagram of an example first embodiment of a lock monitoring device in accordance with the invention, in which the monitoring module communicates with the remote location over a wired communications channel;

FIG. 2 is an illustration of an example second embodiment of a monitoring module in accordance with the invention, in which the monitoring module is capable of communicating over a wireless communications channel;

FIG. 3 is a schematic diagram which illustrates an example embodiment of a lock monitoring and reporting system in accordance with the invention, in which the lock monitoring device of FIG. 1 is used;

FIG. 4 is a swim-lane flow diagram which illustrates an exemplary method for monitoring and reporting lock status changes using the lock monitoring and reporting system of FIG. 3;

FIG. 5 is a block diagram which illustrates an example embodiment of components of an exemplary remotely accessible server described herein;

FIG. 6 is a schematic diagram which illustrates a further example embodiment of an operating device for a lock in accordance with the invention, in which the operating device is connected intermediate the lock and an external input means;

FIG. 7 is a block diagram of an example computing device in which aspects of the invention may be implemented; and

FIG. 8 is a block diagram of an example communication device in which aspects of the invention may be implemented.

### DETAILED DESCRIPTION WITH REFERENCE TO THE DRAWINGS

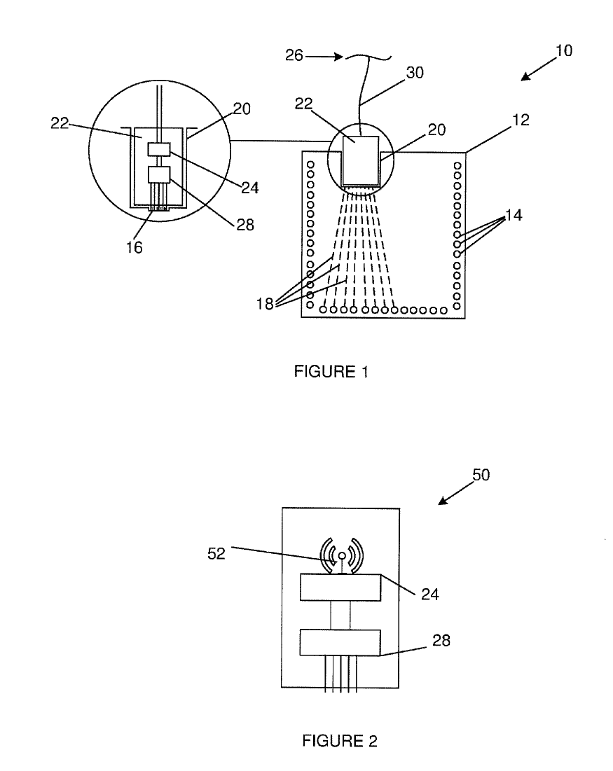

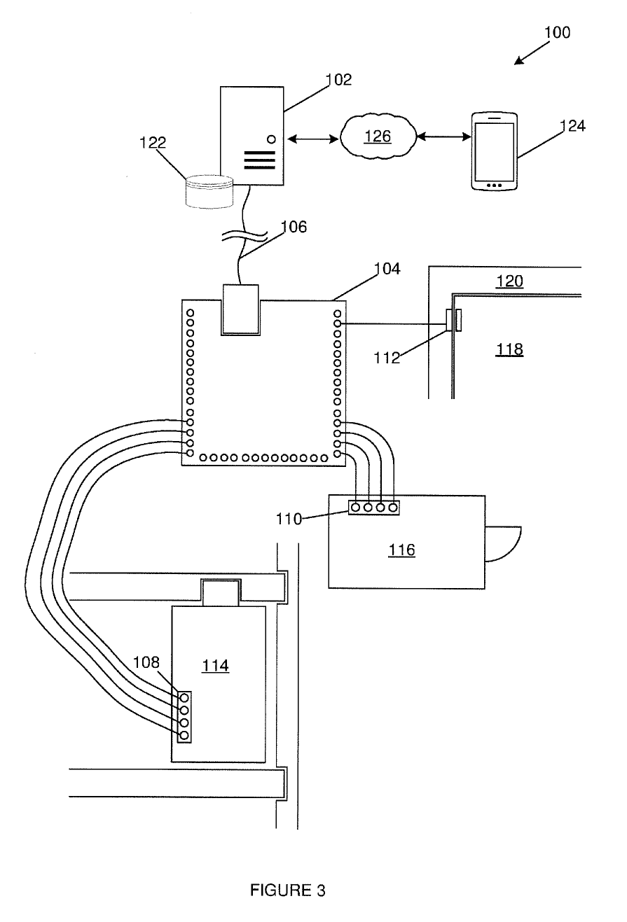

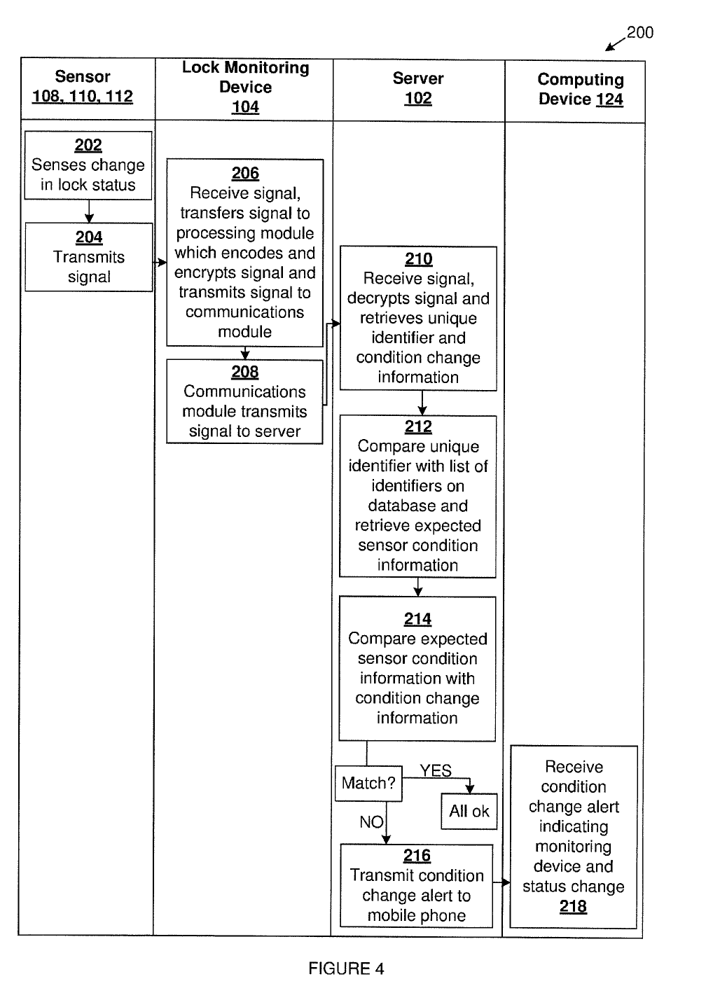

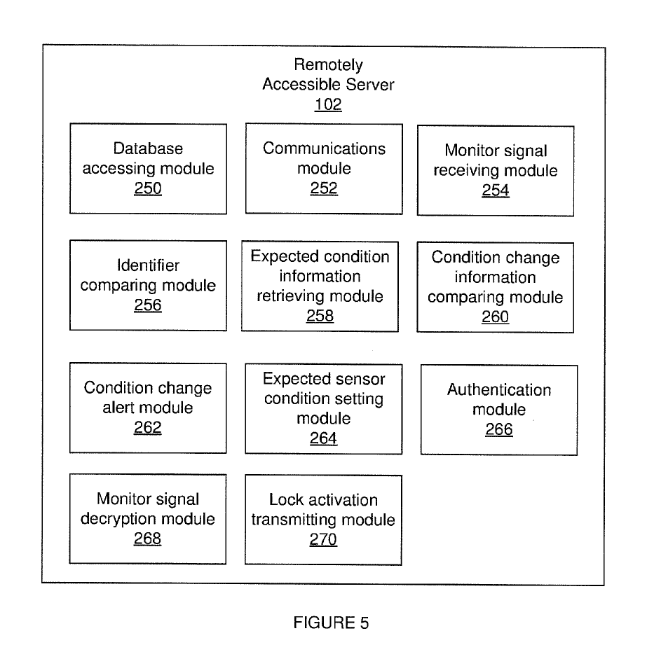

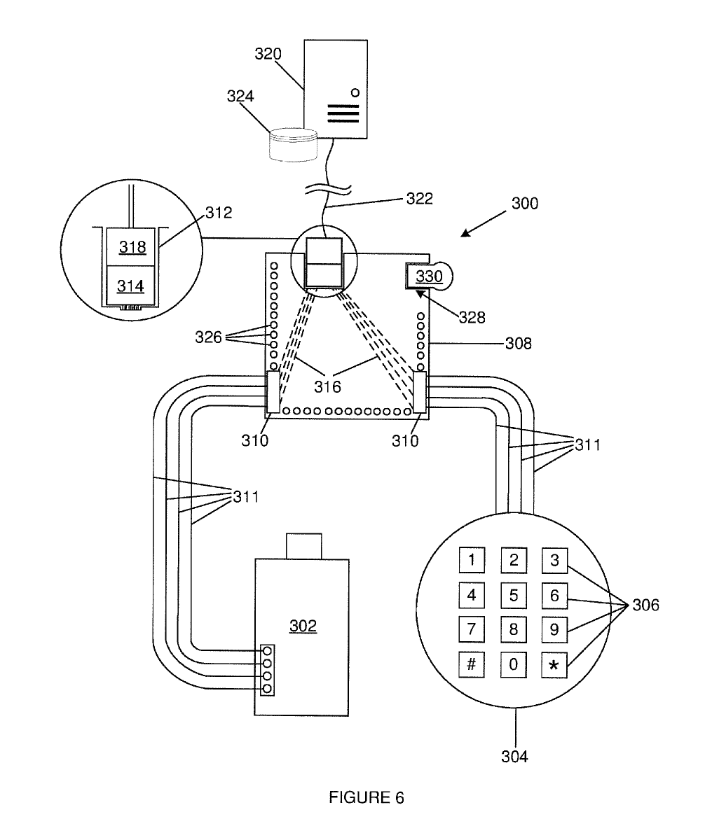

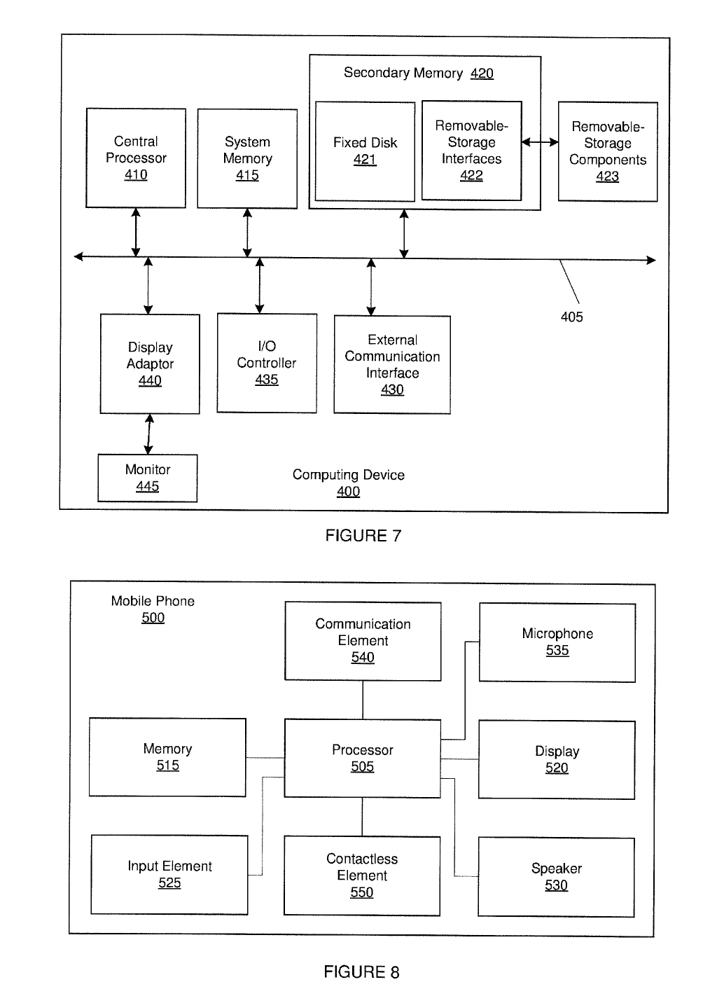

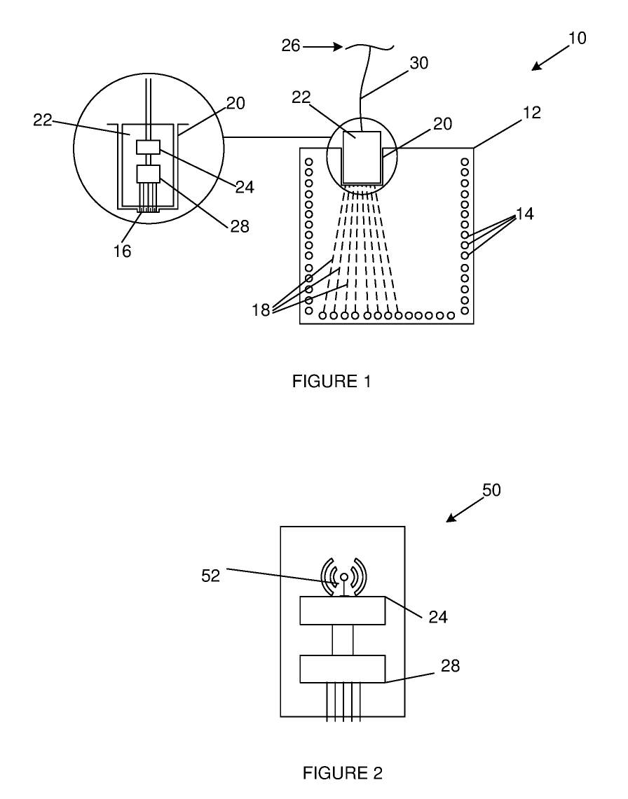

FIG. 1 illustrates an example embodiment of a lock monitoring device (10) as described herein. The lock monitoring device (10) includes a housing (12), preferably having a standard safe lock footprint such as a three or four wheel mechanical combination lock footprint, and made from a plastics material, but any other suitable material may be used. A plurality of ports (14) are provided on the housing (12) with each port (14) connected to a dock (16). In this embodiment the ports (14) are connected to the dock (16) by means of wires (18), but any other suitable means may be used. For clarity purposes only some of the wires (18) are illustrated in FIG. 1. The dock (16) is provided in a socket (20) in the housing (12) and receives, preferably in a plug-in manner, a complementary shaped monitoring module (22).

The monitoring module (22) includes a communications module (24) to enable it to communicate with a remote location (26), and a processing module (28) to encode and preferably encrypt a signal received from one or more of the ports (14). It will be appreciated that in providing the dock (16) in the socket (20), thus externally of the housing, the monitoring module (22) may easily be connected thereto and if needed, replaced or removed for maintenance purposes or the like. Furthermore, the dock (16) and/or monitoring module (22) may be provided with a detent or frangible membrane which is configured to break when the monitoring module (22) is removed from the dock (16) so as to ensure that the monitoring module (22) cannot simply be replaced by a fraudulent third party.

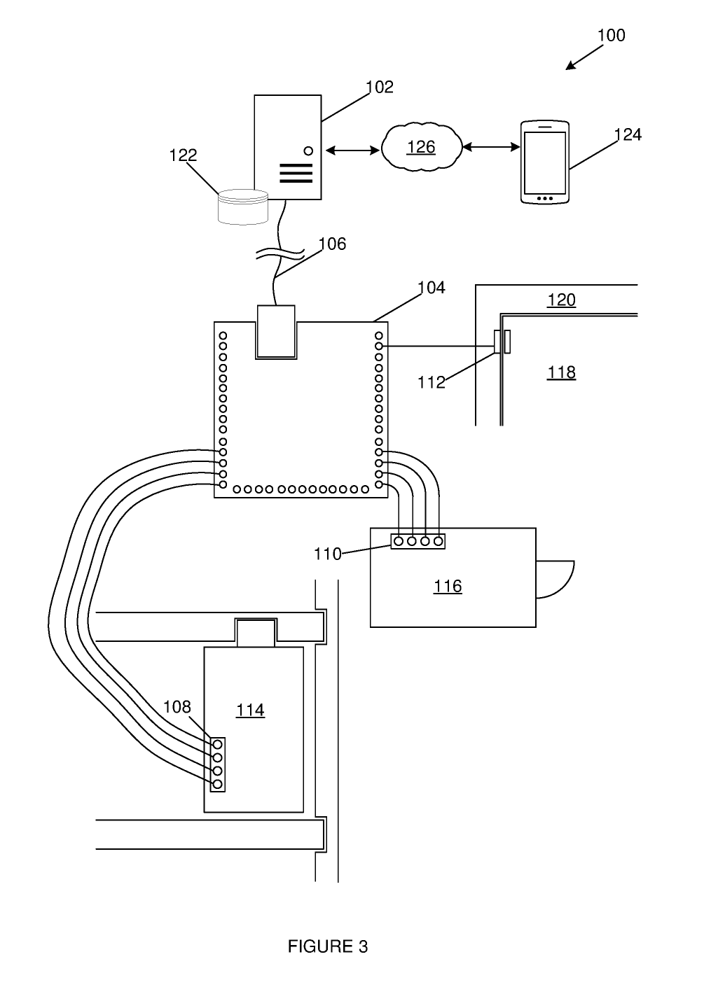

In use and as illustrated in FIG. 3, each port (14) is connected to a sensor (108, 110), preferably utilizing plug-type connectors, with one or more sensors being associated with a lock (114, 116). The sensors are capable of detecting various changes in the status of the lock and to transmit these to the ports (14) which in turn transmit a signal of the detected changes to the monitoring module (22) via the dock (16). The monitoring module (22) receives the signal at the processing module (28) which encodes and encrypts the signal and then transmits the signal to the communications module (24). The communications module (24) then communicates the encrypted monitoring signal to the remote location (26) which may include a computing or communication device capable of processing the monitoring signal. The computing or communication device may include a display device and may be in the form of a mobile phone. Communication between the communications module (24) and the remote location (26) may be over a wired communications channel (30), as illustrated in FIG. 1, or over a wireless communications channel. In the case of a wired communications channel, the monitoring device (10) is preferably powered over the wired cable (30) utilizing I2C protocols or the like.

In addition, the monitoring device (10) is preferably configured to push monitoring signals to the remote location (26) as soon as they are received from the sensors. It will be appreciated that this will significantly increase the speed at which any changes in the status of a lock may be received and/or monitored by the computing device of the remote location (26) since the computing device will not have to continuously enquire from the monitoring device (10) whether a change was detected.

In addition, at least one unique identifier is preferably hardcoded into the processor module (28) which may then be utilized by the computing device to identify the monitoring device (10) which transmitted the signal. The unique identifier may include a variety of alphanumeric strings or characters, for example the street name and number at which the monitoring device (10) has been installed, and preferably includes the geographical coordinates, longitude and latitude, of the monitoring device (10). Alternatively the monitoring device (10) may include a location detection system, such as a Global Positioning System (GPS), a Local Positioning System (LPS), a Wireless Positioning System (WPS) or the like, so as to enable the monitoring device to determine its own geographic location.

In a preferred embodiment, the monitoring device (10) further includes a system which enables it to determine its own altitude, such as a barometric altimeter, an aneroid altimeter, a sensitive altimeter, a phase radio-altimeter, a sonic altimeter, a radar altimeter and the like.

Also, each processing module (28) may have a unique string of characters hardcoded therein which may be used for encryption purposes. For example, the processing module (28) may include a string of characters to identify the person or entity making use of the monitoring device (10), such as the name of the person or entity. This additional string may then be used to encrypt the signal thereby ensuring that only that person or entity will be able to decrypt the signal.

Furthermore, it is envisaged that the monitoring device (10) could further include a hardware key or dongle, if desired, to further enhance security of communication between the monitoring device (10) and the remote location (26). A dongle is a piece of hardware that attaches to an electronic device, typically a computing device, via a USB (Universal Serial Bus) port, mini USB, micro USB, FireWire or the like, for enabling functions such as authorisation of use.

Although the monitoring module illustrated and described with reference to FIG. 1 simply plugs into the socket (20) provided on the housing (12) of the monitoring device (10), it could be secured thereto in any suitable manner. For example, it could require the use of screws, clips or other fasteners to secure it in place. It could further include a frangible detent which breaks if the monitoring module is removed from the socket and in so doing disables operation of either the monitoring device or monitoring module, or both. In this way, unauthorised removal of the monitoring module from the monitoring device can be controlled.

FIG. 2 illustrates an alternative embodiment of a monitoring module (50). The monitoring module (50) of this embodiment is substantially similar to the monitoring module (22) illustrated in FIG. 1, provided that in this embodiment the monitoring module (50) is capable of communicating over a wireless communications channel and includes a wireless antenna (52) in place of or in addition to the a wired communications channel (30) of FIG. 1. The wireless communications channel may include any suitable protocol and be either a private communications network or a public communications network. For example, wireless communication could go over a local wireless network (Wi-Fi), near-field communication (NFC), Bluetooth or infrared, or using a mobile telecommunication network and any suitable protocol, including third generation (3G), fourth generation (4G), high-speed downlink packet access (HSDPA), general packet radio service (GPRS), short message service (SMS), unstructured supplementary service data (USSD), or GSM protocols or the like. Preferably, the monitoring module will include both wired and wireless communication capabilities. In addition, in order to ensure that the monitoring module is always capable of communicating with the remote location, a failsafe structure of different communication protocols can be employed. Thus, for example, when USSD is not available, communication takes place via SMS or 3G, and should these not be available then communication takes place via the wired communications channel.

Referring to FIG. 3, an example embodiment of a lock monitoring and reporting system (100) is provided. The system (100) includes a remotely accessible server (102) in communication with a lock monitoring device (104) over a wired communications channel (106); it will be appreciated that this may alternatively be a wireless communications channel as described above. The lock monitoring device (104) is connected to a number of sensors (108, 110, 112). Two of the sensors (108, 110) are associated with a first and second lock (114, 116), which, in this embodiment, are a sliding bolt lock and a pivoting bolt lock respectively. In the embodiment illustrated, the sliding bolt lock (114) is secured within the door of a safe and its sliding bolt engages with the boltwork of the safe as is well known in the art. Another sensor (112) is a standalone sensor that is simply secured to a door (118) and door frame (120) and which detects whether the door is open or closed. Each lock (114, 116) may be provided with a number of sensors each of which is capable of detecting a different change in the lock's status. For example, one sensor may detect whether the lock is locked or unlocked, another sensor may detect whether the door to which the lock has been secured has been properly closed, and another sensor may detect whether the lock received an opening code or not, if applicable, prior to the lock being opened.

It will of course be appreciated that the remotely accessible server (102) may be in communication with a plurality of lock monitoring devices and the lock monitoring device may be connected to a number of sensors. For clarity, only one lock monitoring device has been illustrated in FIG. 3.

The system (100) further includes a system database (122) on which information associated with each lock monitoring device (104) is stored as well as display device (124), in this embodiment a mobile phone, which is capable of communicating with the remotely accessible server (102) over a wireless communications channel (126), in this embodiment the Internet. The display device (124) may of course also be an application server, personal computer, laptop computer, tablet computer, personal digital assistant or any suitable mobile communications device such as a mobile phone, a smart phone, a smart watch, smart glasses, intelligent clothing or the like. It will be apparent to a person skilled in the art that the display device (124) may also cooperate with a cloud-based server.

The remotely accessible server (102) is configured to receive monitor signals from the lock monitoring device (104) which include a unique identifier of the monitoring device (104) and information of a condition change detected by one of the sensors (108, 110, 112). As described above, the monitoring device (104) is enabled to push the monitoring signals to the remotely accessible server (104). The server (102) is further configured to, upon receiving a monitoring signal, compare the unique identifier with a list of unique identifiers stored on the system database (122) in order to identify the monitoring device (104). Also, signals transmitted by the monitoring device (104) to the remotely accessible server (102) are preferably encrypted, in which case the server (102) is configured to decrypt the signal prior to any processing thereof.

For each unique identifier stored on the system database (122), the system database (122) further includes expected sensor condition information for each monitoring device (104) which is associated with the unique identifier. Once the server (102) has identified the monitoring device (104) which has transmitted the monitoring signal, it retrieves from the system database (122) the expected sensor condition information associated with the unique identifier of the monitoring device (104). The server (102) then compares the information of the condition change detected with the expected sensor condition information retrieved from the system database (122) and, if the information does not match, then it transmits a condition change alert to the display device (124) such as the mobile phone. The condition change alert may be transmitted in electronic format, for example via direct data communication, email communication, SMS communication, USSD communication, or any alternative suitable communication medium. It will of course be appreciated that the server (102) may be configured to transmit the condition change alert to a number of display devices and the alert may furthermore require an acknowledgment or the like. Thus, the alert may require a user to acknowledge the alert prior to an alarm activated by the alert can be de-activated or the like. Also, the server (102) may be configured to activate cameras located in close proximity to the lock upon transmission of the condition change alert and initiate a locking procedure of the lock, either by communicating directly with the lock or communicating with another server that is in communication with the lock. The server may of course also notify local law enforcement or the like by transmitting a condition change alert to a display device thereof.

The expected sensor condition information may be constant or may be altered for a given time. For example, the expected sensor condition information may be set such that the sliding bolt lock (114) will be opened at 9 am each weekday, thus if the lock is opened at that time, the expected sensor condition will be met. Alternatively, the entity making use of the monitoring device (104) could set the opening time of the lock (114) each day, in which case should the lock be opened during the set time, the expected sensor condition will again be met. However, should the lock (114) be opened at a different time, then the expected sensor condition will not be met and the server (102) will transmit a condition change alert to the display device (124). Then again, the opening time of the lock (114) could also be set for a period of time, for example that the lock (114) may be opened during 9 am and 7 pm on any given weekday. If the lock (114) is then opened during such time, the expected sensor condition will be met, however, if the lock (114) were to be opened at 11 pm, then the expected sensor condition will not be met and the server (102) will transmit a condition change alert to the display device (124).

Furthermore, the expected sensor condition information may also include a logical sensor condition. For example, where the sliding bolt lock (114) is secured to a door of a cubicle (not shown) and the pivoting bolt lock (116) is secured to an automatic teller machine (ATM) in the cubicle, then the logical sensor condition for the pivoting bolt lock (116) may be that the sliding bolt lock (114) must be opened prior to the pivoting bolt lock (116) since the pivoting bolt lock (116) can only be reached once the door has been opened. Should the monitoring signal transmitted by the monitoring device (104) indicate that the sliding bolt lock (114) is closed or has not been opened, and that the pivoting bolt lock (116) has been opened, then the logical sensor condition will not be met and the server (102) will transmit a condition change alert to the display device (124). Again, the condition change may be communicated via any suitable communication medium, for example direct communication, SMS, email, USSD or the like. Of course, many other logical sensor conditions can be provided.

In addition, the server (102) may be configured to authenticate the user intending to set expected sensor conditions. In this case, prior to permitting the user to set a condition, the server (102) may request the user to provide a password, biometric identifier, hardware dongle or the like so as to identify the user. Once authenticated, the user will be able to set or modify the expected sensor conditions; however, should the user not be authenticated or the user attempting to set and/or modify the conditions is not authorised thereto, then the server (102) may be configured to transmit an alert to one or more display devices (124).

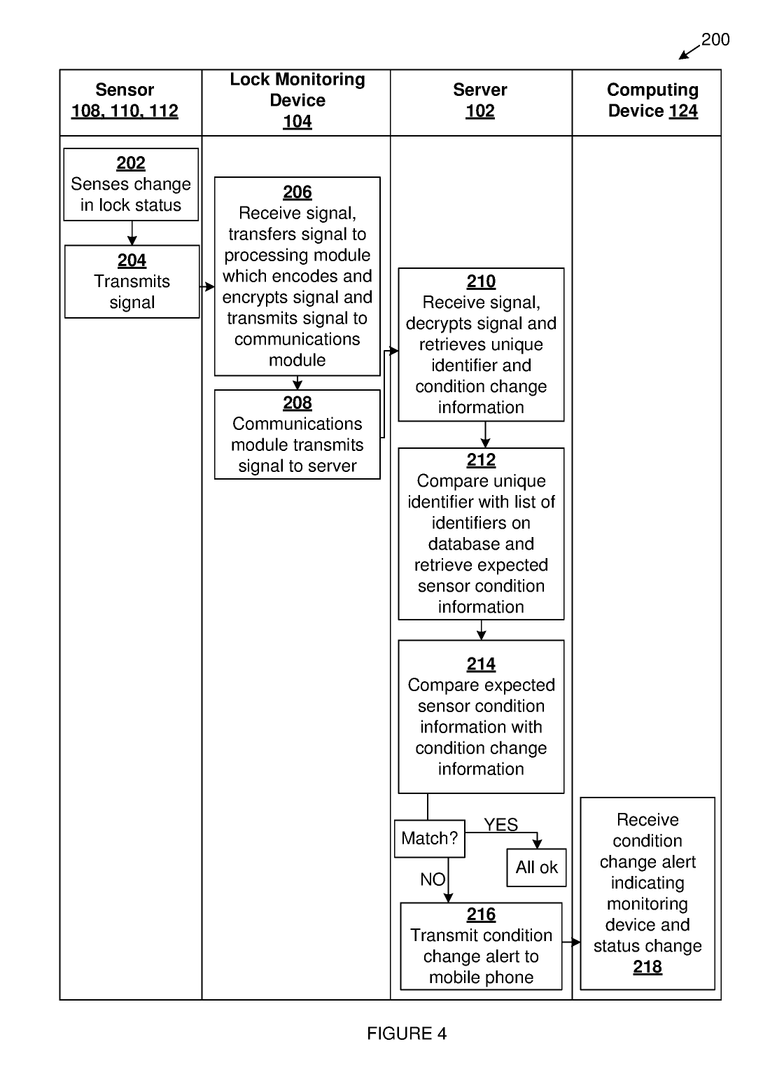

FIG. 4 shows an exemplary method (200) for monitoring and reporting lock status changes on the lock monitoring and reporting system (100) of FIG. 3.

Once the system (100) has been set up by connecting the sensors (108, 110, 112) to the lock monitoring device (104) and in turn connecting the monitoring device (102) to the remotely accessible server (102), wired or wirelessly as the case may be, the expected sensor conditions will have to be set. These can be set using specified software running on a computing device such as an application server, personal computer, laptop computer or the like, and then transmitting these to the server (102) which then stores them on the system database (122). Once everything has been set up, then at a first step (202), a sensor (108, 110, 112) will detect when the status of a lock (114, 116) changes. As described above, this may be that the lock (114, 116) has opened or dosed, what the position of the bolt is relative to the door, whether the lock (114, 116) received an opening code prior to opening and the like. In this embodiment, the status change will be that the sliding bolt lock (114) has been opened.

Once the change has been detected, then at a next step (204), the sensor (108) transmits a signal to the monitoring device (104). Since the lock (114) may have several sensors each dedicated to detecting specific status changes, the signal received or not received by the monitoring device (104) could be as simple as no longer receiving a signal from the particular sensor. Thus, where the sensor detects whether the lock is open or closed, the sensor may simply stop sending a signal to the monitoring device when the door is opened and this would indicate to the monitoring device that the lock is open and that a change took place.

The monitoring device (104) then, at a next step (206), receives the signal from the sensor (108) which is then transmitted to the monitoring module of the monitoring device (104). The processing module of the monitoring device (104) then encodes and encrypts the signal and transmits it to the communications module. At a next step (208), the communications module then transmits the encrypted signal to the remotely accessible server (102). As described above, encryption may be done utilizing a string of characters specific to the entity or person utilizing the system (100) that are hardcoded into the monitoring device (104).

At a next step (210), the server (102) receives the encrypted signal, decrypts the signal and retrieves the information therein. The information will at a minimum include the unique identifier of the monitoring device (104), as well as condition change information which indicates what status change of the lock (114) was detected by the sensor (108). In this case, that the lock (114) was opened.

At a next step (212), the server (102) then compares the received unique identifier with a list of identifiers stored on the system database (122) and retrieves from the system database (122) expected sensor condition information associated with the unique identifier.

The server (102) then, at a next step (214), compares the retrieved expected sensor condition information with the condition change information received from the monitoring device (104). If the information matches, then nothing happens. However, if the information does not match, therefore indicating that the lock (114) should not have been opened, then, at a next step (216), the server (102) transmits a condition change alert to the display device (124) which may be in the form of a mobile phone indicating that there is a problem and that the lock (114) has been opened. The display device (124) receives (218) the condition change alert indicating the monitoring device and status change and displays this to a user.

It will be appreciated that the method described above can be effected by the remotely accessible server for a number of lock monitoring devices simultaneously, thus enabling an entity, for example a financial institution, to effectively monitor all the locks that it has in operation. It is envisaged that the computing device will run specified software which will enable a user to conveniently monitor all locks and/sensors employed and that in the event of a condition change alert, the software will indicate which lock has been effected and what the status change is and to react thereon as appropriate.

Also, since the monitoring device can be used for a number of and a variety of different locks, a user will not be required to install different locks in order to monitor all at the same time and utilizing the same software. The monitoring device thus provides a convenient solution to enable entities which make use of a number of different locks or sensors to monitor all of them without having to replace them with the same manufacturer's locks or sensors.

In addition, it will be appreciated that the described lock monitoring device may be employed for any type and form or lock such as for example, doors to vending machines or inside vending machines to monitor events such as for example stock levels, doors to compartments within ATM machines that report non-financial events such as paper out on printers, cabinet doors to monitor general access.

In addition, the monitoring device may also be installed in a vehicle and, for example, in the event that one of the vehicle's doors remain open for longer that a predefined period of time, the server would determine that the condition change does not match an expected sensor condition and thus send an alert to a display device, which may be the vehicle owner's mobile device. Furthermore, one or more monitoring device could be installed at a residence, with each monitoring device being connected to one or more locks and sensors at the residence. In such a case, the owner, when going on holiday, could set the expected sensor conditions so that none of the locks should be open. Thus, in the event that one of the sensors detects that a lock is open, the server will immediately transmit an alert. Also, the device may be installed in place of a lock in a dual lock safe vault. Dual lock safe vaults include two separate locks, for example two combination locks, for increased security since typically two users will be required to open the safe. Nevertheless, in practice often only one lock is utilized for convenience purposes and in such a case one of the locks could simply be replaced by the lock monitoring device.

Furthermore, various sensors may be employed to monitor a variety of conditions. The sensors could for example determine whether a lock is open or closed, whether the lock is openable or not, whether the locks time delay is counting, whether the motor is in the open position, whether a duress code has been entered, whether the lock is in a programming mode, whether the bolt is retracted, what the battery levels of the lock are, whether the lock is experiencing a hardware fault and the like. Alternatively the sensors may be capable of detecting and/or recording sound and/or visual data which can then be transmitted to a computing device for analysis. For example, a sound sensor may be utilized which could detect any variation in sound, for example the sound a bolt being cut by an angle grinder or the like. In such a case, the detected sound may be transmitted to a computing device for analysis in order to determine what sound is being detected. In the event that it is determined that it is in fact the sound of an angle grinder cutting a bolt, the server will transmit a condition change alert and/or the server or the sensor will sound an alarm. Also, in the case where the monitoring module is capable of determining its latitude, it would automatically detect if the device in which it has been secured is being lifted or lowered. Many other conditions or sensors may be employed as is known in the art, and all of them can be conveniently monitored utilizing the same software and monitoring device.

It will be appreciated that many other lock monitoring devices, monitoring modules and lock monitoring and reporting systems which fall within the scope of the invention, particularly as regards the shape, configuration and operation thereof. For example, the sensors and/or ports to which the sensors are connected may be provided with means which prevent tampering of the sensors. Thus, where a sensor of a lock is being replaced, the monitoring device will be capable of detecting this and immediately transmit the sensed condition to the remotely accessible server.

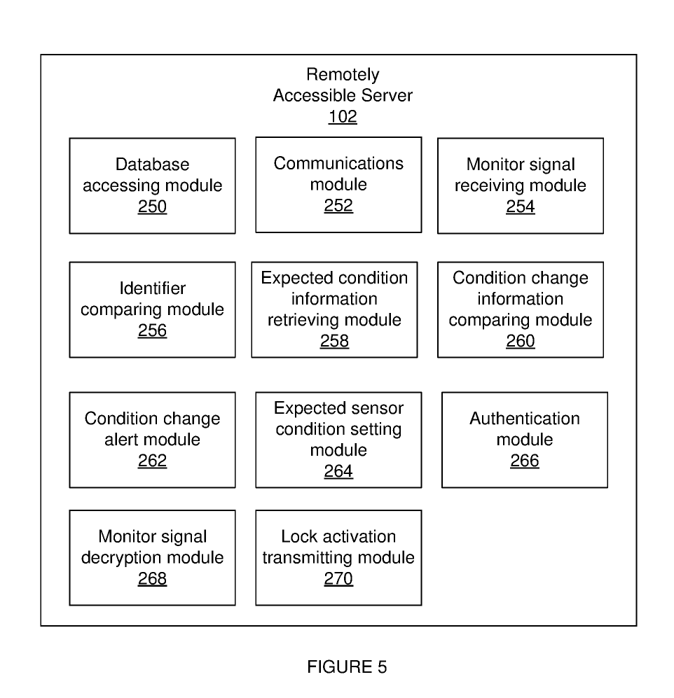

FIG. 5 is a block diagram which illustrates components of an example embodiment of the remotely accessible server (102) described above. The remotely accessible server (102) may include at least one processor, a hardware module, or a circuit for executing the functions of the described modules which may be software units executing on the at least one processor. The remotely accessible server (102) has a database accessing module (250) arranged to provide access to the database (122). The remotely accessible server (102) also has a communications module (252) configured to enable the server (102) to communicate with at least one lock monitoring device (104). As described above, communication may be over a wired communications channel (106) or a wireless communications channel.

The remotely accessible server (102) includes a monitor signal receiving module (254) for receiving a monitor signal from one or more lock monitoring devices (104). The monitor signal includes a unique identifier of the lock monitoring device (104) which transmits the signal and information of a condition change detected by a sensor (108, 110, 112) associated with a lock (114, 116).

The remotely accessible server (102) includes an identifier comparing module (256) that is configured to compare the received unique identifier of the lock monitoring device (104) with a list of identifiers stored on the database (122) in order to identify the lock monitoring device (104) that transmitted the monitor signal.

The remotely accessible server (102) includes an expected condition information retrieving module (258) for retrieving expected sensor condition information associated with the unique identifier of the lock monitoring device (104) from the database (122). The expected sensor condition information may include a logical sensor condition.

The remotely accessible server (102) includes a condition change information comparing module (260) for comparing the information of the condition changed detected with the expected sensor condition information.

The remotely accessible server (102) includes a condition change alert module (262) which transmits a condition change alert to one or more display devices (124) when the condition change information comparing module (260) determines that the information of the condition changed detected does not match the expected sensor condition information.

The remotely accessible server (102) may further include an expected sensor condition setting module (264) through which expected sensor conditions may be set or configured and to then associate such expected sensor conditions with a particular lock monitoring device (104). In this regard, the remotely accessible server (102) may further include an authentication module (266) which authenticates a user prior to enabling the user to set or configure an expected sensor condition. It will be appreciated that this will be of particular relevance in order to prevent unauthorised tampering and configuring of expected sensor conditions.

In an embodiment, communication between the remotely accessible server (102) and lock monitoring device (104) is encrypted. In this case, the remotely accessible server (102) further includes a monitor signal decryption module (268) to permit decryption of the received monitor signal.

In an embodiment, the remotely accessible server (102) may be in communication with the lock (114, 116) and capable of transmitting operating instructions to the lock (114, 116). In this case, the remotely accessible server (102) further includes a lock activation transmitting module (270) which is configured to transmit a lock activation notification to the lock (114, 116) to initiate a locking procedure in the event that the condition change information comparing module (260) determines that the information of the condition changed detected does not match the expected sensor condition information.

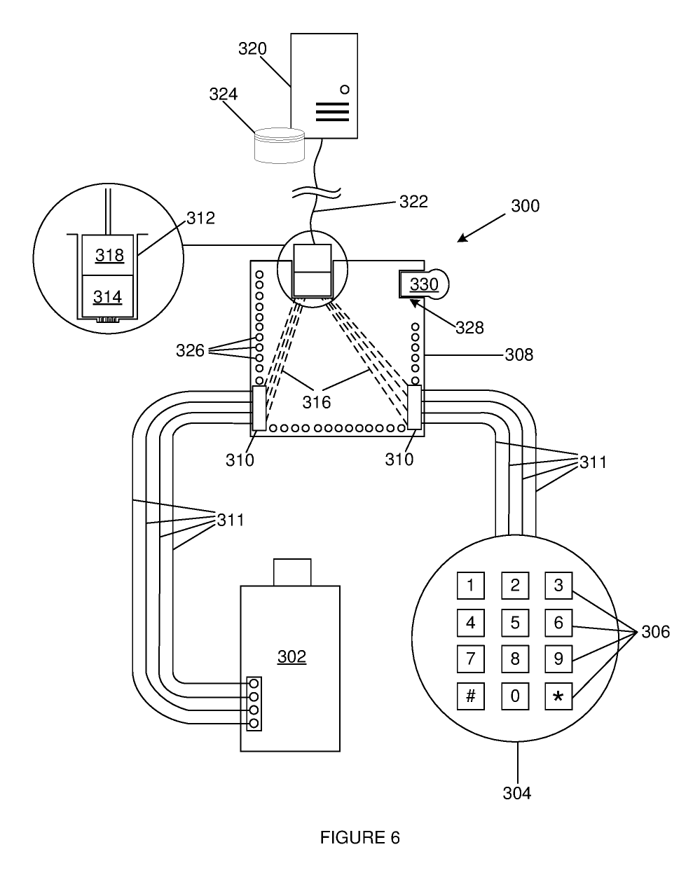

FIG. 6 illustrates a further embodiment of an operating device (300) for a lock (302). The lock (302) includes an internal processor (not shown) and an external input means (304) connected to the internal processor and which permits operating instructions to be provided thereto. In this embodiment, the operating device (300) is connected intermediate the internal processor of the lock (302) and the external input means (304) as will be described further below. The external input means (304) is in this embodiment a twelve key (306) keypad (304) which transmits different voltages to the internal processor based on different resistor values triggered by each of the twelve keys (306). Of course, any other suitable input means may be used. The lock (302) is typically secured within a door or the like with the keypad (304) secured to an external surface of the door or other surface to provide access for a user intending to open the lock (302).

The operating device (300) comprises a housing (308), preferably having a standard lock footprint such as a three or four wheel mechanical combination lock footprint, and made from a plastics material, but any other suitable material may be used. The footprint of the housing (308) is selected so as to facilitate securing thereof on top or adjacent the lock (302). The housing (308) includes one or more processor ports (310), typically two, which permits the housing (308) to be connected to the internal processor of the lock (302) and the keypad (304). In the embodiment illustrated, the internal processor of the lock (302) is typically connected to the keypad (304) by means of four wires (311) and the operating device (300) is simply connected intermediate the internal processor and the keypad (304) by connecting the wires (311) from the keypad (304) to one of the processor ports (310) and then connecting new wires (311) from another processor port (310) to the lock (302). Alternatively, the wires (311) connecting the keypad (304) to the lock (302) could simply be cut and the operating device (300) connected by then securing the free ends of the wires (311) to the processor ports (310).

The housing further includes a dock (312) which receives, preferably in a plug-in manner, a complementary shaped external processor module (314). The external processor module (314) may of course also be provided within the housing (308), however, it is preferred that the processor module (314) is removably secured to the housing (308) so as to permit easy access for maintenance and/or replacement thereof. The dock (312) is connected to the processor ports (310) by means of wires (316), but any other suitable means may be used. In this way a connection between the processor ports (310) and the external processor module (314) and thus a connection between the internal processor of the lock (302), the external processor module (314) and the keypad (304) is established.

The external processor module (314) is attached to or integral with a communications module (318) which enables communication between the processor module (314) and a remote location (320). In this embodiment communication between the communications module (318) and the remote location (320) is over a wired communications channel (322), however, the communications channel may of course also be a wireless channel utilizing 3G, 4G or any other communication protocols. The remote location is in this embodiment a server (320) which has a database (324) associated therewith, but it may of course be any other suitable computing device.

The external processor module (314) is operable and/or configured to receive operating instructions from the server (320) via the communications module (318) and to provide the operating instructions to the internal processor of the lock (302) in the same format as those which the keypad (304) would typically provide. The operating device (300) thus enables operation of the lock (302), such as opening and/or closing the lock (302) from the remote location (320), but any other operating instructions may also be provide as will be described in more detail further below. It will of course be appreciated that since the external processor module (314) is connected intermediate the internal processor and the keypad (304), any signals or operating instructions transmitted from the keypad (304) will be directed through the external processor module (314) to the internal processor.

The operating device (300) further includes a number of sensor ports (326) that are provided on the housing (308) and which permit sensors (not shown) on the lock (302) to be connected to the operating device (300) by means of wires or the like. In this way external processor module (314) is enabled to monitor such sensors and communicate any detected changes to the server (320) via the communications module (318).

In addition, at least one unique identifier is hardcoded into the external processor module (314) which is used to encrypt any communications between the communications module (318) and the server (320). Furthermore, and as illustrated in FIG. 6, the housing (308) further includes a connector (328) which is shaped to receive a security key or dongle (330) and to be connected to the external processor module (314) so as to further enhance security of communication between the communications module (318) and the server (320).

It will be appreciated that once the operating device (300) has been connected intermediate the internal processor of the lock (302) and the keypad (304), operating instructions including programming or re-programming instructions may be transmitted to the internal processor. This will significantly facilitate programming or re-programming, such a re-programming the PIN or password required to operate the lock (302) since programming thereof will not require a user to be physically present, but rather this can be done from a remote location. This will be of particular relevance where an entity, typically a bank, has hundreds or even thousands of such locks in operation since the operating device (300) will enable re-programming of all or at least part of the locks at the same time. This will significantly reduce the time and cost involved with such reprogramming, which often has to take place more than once a year.

Also, operation of a lock from a remote location may be of particular convenience when for example a burglary has taken place at a premises. In such a case, when the police arrives at the premises, the door or doors can be easily opened from the remote location without requiring a person having a key to the premises to arrive or for the police to break down the door.

Furthermore, since re-programming of the lock can take place from a remote location, the operating device will provide a one-time PIN functionality to the lock. For example, when a user intends to open the lock, the user can communicate to the server that he/she is in close proximity to the lock to which the server may then be configured to transmit a PIN to a communications device of the user, re-program the lock to open when the PIN is input on the keypad, and thus enable the user to open the lock.

Also, and as is well known in the art, the signals or voltages transmitted by the keypad to the internal processor of the lock are typically variations dependent on different resistor values triggered by each of the different keys on the keypad. For example, where the keypad has twelve keys which are divided into four rows of three keys each, the keypad may transmit 1.1 volts for the first key of the first row, 1.2 volts for the second and 1.3 volts for the third, while transmitting 2.1 volts for the first key of the second row and so on. The signals transmitted are thus very simple voltage transmission and the external processor of the operating device can thus comprise a very basic low cost processor. It will of course be appreciated that the instead of voltage variations, the external processor could determine variations in current and utilize these to operate the lock.

In addition, since the operating device provides for sensors of the lock to be connected to the external processor, the operating device enables monitoring of the locks as well as operation thereof.

It will be appreciated that many other operating devices for locks exist which fall within the scope of the invention, particularly as regards the shape, configuration and operation thereof. For example, the external processor module and communications module may be housed within the housing and communication may be over any suitable communications channel. Also, multiple locks or multiple keypads may be connected to the same operating device and any suitable lock having an internal processor may be connected to the operating device.

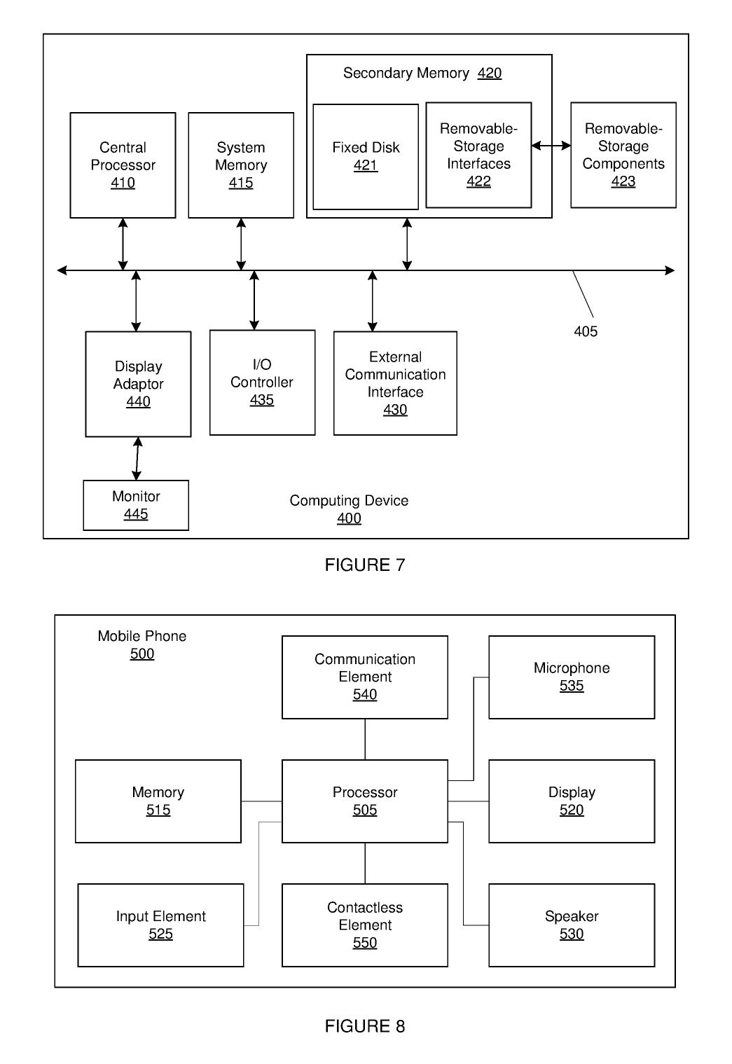

FIG. 7 illustrates an example of a computing device (400) in which various aspects of the disclosure may be implemented such as the remotely accessible server (102) and/or the display device (124). The computing device (400) may be suitable for storing and executing computer program code. The computing device (400) may include subsystems or components interconnected via a communication infrastructure (405) (for example, a communications bus, a cross-over bar device, or a network). The computing device (400) may include one or more central processors (410) and at least one memory component in the form of computer-readable media. In some configurations, a number of processors may be provided and may be arranged to carry out calculations simultaneously. In some implementations, a number of computing devices (400) may be provided in a distributed, cluster or cloud-based computing configuration and may provide software units arranged to manage and/or process data on behalf of remote devices.

The memory components may include system memory (415), which may include read only memory (ROM) and random access memory (RAM). A basic input/output system (BIOS) may be stored in ROM. System software may be stored in the system memory (415) including operating system software. The memory components may also include secondary memory (420). The secondary memory (420) may include a fixed disk (421), such as a hard disk drive, and, optionally, one or more removable-storage interfaces (422) for removable-storage components (423). The removable-storage interfaces (422) may be in the form of removable-storage drives (for example, magnetic tape drives, optical disk drives, etc.) for corresponding removable storage-components (for example, a magnetic tape, an optical disk, etc.), which may be written to and read by the removable-storage drive. The removable-storage interfaces (422) may also be in the form of ports or sockets for interfacing with other forms of removable-storage components (423) such as a flash memory drive, external hard drive, or removable memory chip, etc.

The computing device (400) may include an external communications interface (430) for operation of the computing device (400) in a networked environment enabling transfer of data between multiple computing devices (400). Data transferred via the external communications interface (430) may be in the form of signals, which may be electronic, electromagnetic, optical, radio, or other types of signal. The external communications interface (430) may enable communication of data between the computing device (400) and other computing devices including servers and external storage facilities. Web services may be accessible by the computing device (400) via the communications interface (430). The external communications interface (430) may also enable other forms of communication to and from the computing device (400) including, voice communication, near field communication, radio frequency communications, such as Bluetooth™, etc.

The computer-readable media in the form of the various memory components may provide storage of computer-executable instructions, data structures, program modules, software units and other data. A computer program product may be provided by a computer-readable medium having stored computer-readable program code executable by the central processor (410). A computer program product may be provided by a non-transient computer-readable medium, or may be provided via a signal or other transient means via the communications interface (430).

Interconnection via the communication infrastructure (405) allows the central processor (410) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, and the like) may couple to the computing device (400) either directly or via an I/O controller (435). These components may be connected to the computing device (400) by any number of means known in the art, such as a serial port. One or more monitors (445) may be coupled via a display or video adapter (440) to the computing device (400).

FIG. 8 shows a block diagram of a communication device (500) which may be provided as a form of the described display device (124). The communication device (500) may be a cell phone, a feature phone, a smart phone, a satellite phone, or a computing device having a phone capability.

The communication device (500) may include a processor (505) (e.g., a microprocessor) for processing the functions of the communication device (500) and a display (520) to allow a user to see the phone numbers and other information and messages. The communication device (500) may further include an input element (525) to allow a user to input information into the device (e.g., input buttons, touch screen, etc.), a speaker (530) to allow the user to hear voice communication, music, etc., and a microphone (535) to allow the user to transmit his or her voice through the communication device (500). The processor (510) of the communication device (500) may connect to a memory (515). The memory (515) may be in the form of a computer-readable medium that stores data and, optionally, computer-executable instructions.

The communication device (500) may also include a communication element (540) for connection to communication channels (e.g., a cellular telephone network, data transmission network, Wi-Fi™ network, satellite-phone network, Internet network, Satellite Internet Network, etc.). The communication element (540) may include an associated wireless transfer element, such as an antenna. The communication element (540) may include a subscriber identity module (SIM) in the form of an integrated circuit that stores an international mobile subscriber identity and the related key used to identify and authenticate a subscriber using the communication device (500). One or more subscriber identity modules may be removable from the communication device (500) or embedded in the communication device (500).

The communication device (500) may further include a contactless element (550), which is typically implemented in the form of a semiconductor chip (or other data storage element) with an associated wireless transfer element, such as an antenna. The contactless element (550) may be associated with (e.g., embedded within) the communication device (500) and data or control instructions transmitted via a cellular network may be applied to the contactless element (550) by means of a contactless element interface (not shown). The contactless element interface may function to permit the exchange of data and/or control instructions between mobile device circuitry (and hence the cellular network) and the contactless element (550). The contactless element (550) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth™, infra-red, or other data transfer capability that can be used to exchange data between the communication device (500) and an interrogation device. Thus, the communication device (500) may be capable of communicating and transferring data and/or control instructions via both a cellular network and near field communications capability.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, modules or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A lock monitoring device which includes a housing securable to or adjacent a lock with a plurality of ports provided on the housing for wired connection to one or more sensors, each port connected to a dock in which is received a monitoring module, the monitoring module including a communications module capable of communicating with a remote location to send a monitor signal thereto and a processing module configured to encode the monitor signal, wherein at least one of the sensors are associated with a lock and arranged to sense a condition of the lock, and wherein the monitor signal includes a unique identifier of the lock and information of a condition change detected by the at least one sensor associated with the lock.

2. The lock monitoring device as claimed in claim 1, wherein the dock is accessible externally of the housing.

3. The lock monitoring device as claimed in claim 1, wherein the housing has a standard safe lock footprint.

4. The lock monitoring device as claimed in claim 1, wherein the communications module communicates with the remote location over a wired or wireless communication channel and such communication is encrypted.

5. The lock monitoring device as claimed in claim 1, wherein the monitoring module is configured to push information to the remote location.

6. The lock monitoring device as claimed in claim 1, wherein the monitoring device is capable of receiving a hardware key or a high security dongle.

7. The lock monitoring device as claimed in claim 1, wherein the monitoring device is capable of sounding an alarm or siren in response to changes detected by the one or more sensors.

8. (canceled)

9. A lock monitoring and reporting method, the method including the steps of, at a remotely accessible server:
receiving a monitor signal from a lock monitoring device, the monitor signal including a unique identifier of a lock and information of a condition change detected by a sensor associated with the lock;
comparing the received unique identifier with a list of identifiers stored on a system database and retrieving expected sensor condition information associated with the unique identifier of the lock;
comparing the condition change information with the retrieved expected sensor condition information; and
if the condition change information does not match the expected sensor condition information transmitting a condition change alert to a display device.

10. The lock monitoring and reporting method as claimed in claim 9, wherein the expected sensor condition information includes a logical sensor condition.

11. The lock monitoring and reporting method as claimed in claim 9, wherein the remotely accessible server is in communication with the lock, and wherein the method includes initiating a locking procedure of the lock in the event that the condition change information does not match the expected sensor condition information.

12. The lock monitoring and reporting method as claimed in claim 9, including sounding an alarm or siren or activating cameras located in close proximity to the lock monitoring device in the event that the condition change information does not match the expected sensor condition information.

13. The lock monitoring and reporting method as claimed in claim 9, wherein the remotely accessible server is in communication with a plurality of lock monitoring devices each of which is in communication with one or more sensors associated with one or more locks.

14. A lock monitoring and reporting system, the system including a remotely accessible server comprising:
a monitor signal receiving module which receives a monitor signal from a lock monitoring device, the monitor signal including a unique identifier of the lock monitoring device and information of a condition change detected by a sensor associated with a lock;
an identifier comparing module which compares the unique identifier of the lock monitoring device with a list of identifiers stored on a system database;
an expected condition information retrieving module which retrieves from the system database expected sensor condition information associated with the unique identifier of the lock monitoring device;
a condition change information comparing module which compares the information of the condition change detected by the sensor with the expected sensor condition information; and
a condition change alert module which transmits a condition change alert to one or more display devices when the information of the condition change detected by the sensor does not match the expected sensor condition information.

15. The lock monitoring and reporting system as claimed in claim 14, wherein the remotely accessible server further includes:
an expected sensor condition setting module which enables setting of expected sensor conditions and to associate them with a lock monitoring device; and
an authentication module which authenticates a user prior to enabling setting of expected sensor conditions.

16. (canceled)

17. (canceled)

18. (canceled)

19. (canceled)

20. (canceled)

21. The lock monitoring and reporting method as claimed in claim 9, wherein the received monitor signal includes a sensor condition of two or more sensors monitored by the monitoring device, and wherein the logical sensor condition includes a predetermined combination of the two or more received sensor conditions.
